(19) United States
(12) Patent Application Publication
(10) Pub. No.: US 2004/0092695 A1
(43) Pub. Date: May 13, 2004

(54) Biodegradable polyurethane elastomer and preparation process thereof

(75) Inventors: Ping Hu, Beijing (CN); Tao Han, Beijing (CN)

Correspondence Address: MILLEN, WHITE, ZELANO & BRANIGAN, P.C., 2200 CLARENDON BLVD., SUITE 1400, ARLINGTON, VA, 22201, US

(73) Assignee: TSINGHUA UNIVERSITY, Beijing (CN)

(21) Appl. No.: 10/644,077

(22) Filed: Aug. 20, 2003

(30) Foreign Application Priority Data
Aug. 23, 2002 (CN) 02129487.9

(51) Int. Cl. C08G 18/00

(52) U.S. Cl. 528/44

(57) ABSTRACT

The present application provides a biodegradable polyurethane elastomer comprising soft segments A and B, and hard segment C, wherein: the segment A is formed from poly(β-hydroxybutyrate) diol and optional one or more components selected from the group consisting of poly(lactic acid)diol, polyglycolide diol, polylactide diol, polycaprolactone(PCL) diol and poly(lactic/glycolic acid) diol; the segment B is formed from polyethylene glycol; the segment C is formed from one or more diisocyanate selected from the group consisting of 1,6-hexamthylene diisocyanate, isophorone diisocyanate and lysine diisocyanate; and the molar ratio of these segments are: (A+B)/C=0.8 to 1.2; A/B=0.1 to 10; and the amount of the poly-β-hydroxybutyrate units in the segment A is 10-100 mol %.

### FIELD OF THE INVENTION

This invention relates to biodegradable materials, especially relates to a biodegradable and hydrophilic polyurethane elastomer with poly-β-hydroxybutyrate (PHB) as one of its raw materials, and a preparation process thereof.

### BACKGROUND OF THE INVENTION

Polyurethane elastomers are suitable to be used in the field of cardiovascular system engineering for their good mechanical properties, excellent biocompatibility and anticoagulation property. The main problem encountered while using polyurethanes as bioabsorbable material is that the decomposition products of diisocyanate are toxic. It has been found that the decomposition products of 1,6-hexamthylene diisocyanate (HDI, Mw168, C₈H₁₂N₂O₂), isophorone diisocyanate (IPDI, Mw222, C₁₂H₁₈N₂O₂), lysine diisocyanate (LDI, Mw196, C₈H₁₂N₄O₂), and polycaprolactone (PCL), poly-lactic acid (PLA), polyglycolide, polylactide and poly lactic/glycolic acid (PLGA) are innoxious micromoleculars or human metabolism products. Therefore, it has become a trend in the art to choose human metabolism products as the monomers for the synthesis of innoxious bioabsorbable materials.

B. Bogdanov reported (Polymer, 1999, 40, 3171-3182) the preparation of segmented poly(ester-urethanes) (PEUs) based on poly(ε-caprolactone) (PCL) as a soft segment. The preparation process comprises the following steps: Firstly, poly(ε-caprolactone)diol (PCL-diol) was synthesized by ring-open polymerization of ε-caprolactone initiated with 1,6-hexanediol. Then the PCL-diol was heated with butanediol and 1,1′-methylene-bis(4-isocyanatocyclohexane) to produce biodegradable polyurethane elastomer with excellent mechanical properties. Since this kind of polyurethane is formed from polycaprolactone, it releases innoxious products after decomposition. However, since the soft segment of this polyurethane is made from polycaprolactone, which has poor hydrophilicity, therefore, the biocompatibility and anticoagulation property of the polyurethane is poor and thus its application is limited.

JENÖ BORDA et al. (Journal of Polymer Science: Part A: Polymer Chemistry, 2000, Vol. 38, 2925-2933) reported the synthesis of biodegradable linear polyurethanes by the reaction of polylactic acid (PLA) oligomers with isocyanates, wherein the optimum reaction conditions were provided.

There is a need to prepare polyurethanes having both excellent biodegradability and biocompatibility. No any published patent or article has reported works on adjusting simultaneously the biodegradability and biocompatibility of polyurethanes.

### SUMMARY OF THE INVENTION

The object of the present invention is to provide a polyurethane elastomer having excellent, adjustable biodegradability and biodegradability, which will not release toxic products after decomposition.

The other object of the present invention is to provide a preparation process of the polyurethane elastomer.

Accordingly, the present invention provides a biodegradable polyurethane elastomer comprising soft segments A and B, and hard segment C, wherein:

The segment A is formed from poly(β-hydroxybutyrate) diol and optional one or more components selected from the group consisting of poly(lactic acid)diol, polyglycolide diol, polylactide diol, polycaprolactone(PCL) diol and poly(lactic/glycolic acid) diol;

The segment B is formed from polyethylene glycol;

The segment C is formed from one or more diisocyanate selected from the group consisting of 1,6-hexamthylene diisocyanate, isophorone diisocyanate and lysine diisocyanate;

And the molar ratio of these segments are: (A+B)/C=0.8 to 1.2; A/B=0.1 to 10; and the amount of the poly-β-hydroxybutyrate units in the segment A is 10-100 mol %.

The present invention also provides a process for preparing a biodegradable polyurethane elastomer. The process comprises the following steps:

1) poly-β-hydroxybutyrate is mixed with a glycol of C₂-C₁₈ and alcoholysized under heat reflux;

2) the product of step 1) was purified via extraction to obtain poly(β-hydroxybutyrate)diol oligomer;

3) polyethylene glycol and optionally one or more components selected from the group consisting of polycaprolactone diol, poly(lactic acid) diol, polyglycolide diol, polylactide diol and poly(lactic/glycolic acid) diol are added into the poly(β-hydroxybutyrate)diol oligomer, and the mixture is heated under nitrogen protection, and then one or more diisocyanates selected from the group consisting of 1,6-hexamthylene diisocyanate (HDI), isophorone diisocyanate (IPDI) and lysine diisocyanate (LDI) are added into the reaction mass, and the reaction is carried out at 80° C.-150° C.;

4) the reaction product is cooled and the biodegradable polyurethane elastomer of the present invention is obtained.

### BRIEF INTRODUCTION OF THE DRAWINGS

FIG. 1 shows the plot of water contact angles of the biodegradable polyurethane elastomers of the present invention vs. polyethylene glycol contents therein;

FIG. 2 shows the comparison of the water contact angles of the biodegradable polyurethane elastomers of the present invention with those of the prior art products;

FIG. 3 shows the plot of water-absorbing capacities of the biodegradable polyurethane elastomers of the present invention vs. time;

FIG. 4 shows the comparison of the balanced water-absorbing capacities of the biodegradable polyurethane elastomers of the present invention with those of the prior art products;

FIG. 5 shows the plot of the residue weight of the polyurethane elastomers of the present invention after decomposition in a buffer solution vs. time;

FIG. 6 shows the comparison of the residue weights of the biodegradable polyurethane elastomers of the present invention with those of the prior art products, after being decomposed in a buffer solution for 10 weeks.

### DETAILED DESCRIPTION OF THE INVENTION

This invention provides a biodegradable polyurethane elastomer with poly-β-hydroxybutyrate (PHB) as one of its raw materials.

Poly-β-hydroxybutyrate (PHB) is a photoactive polymer of D(−)-3-hydroxybutanoic acid, and it can be produced by many bacteria. As a carbon and energy storage polymer, it can be found in cytoplasm in the form of particles. Poly-β-hydroxybutyrate has excellent biocompatibility, when used in human body, it does not cause inflammation and rejection, and can be easily decomposed. Therefore, it is suitable for medical application.

The inventor of this invention found that the polyurethane elastomers formed from Poly-β-hydroxybutyrate have excellent biodegradability, biocompatibility and mechanical properties, and thus they are quite satisfactory for medical application, such as tissue engineering and cardiovascular system.

In the present invention, each of the polymers that form the segment A, i.e., poly(β-hydroxybutyrate)diol and the optional one or more components selected from the group consisting of poly(lactic acid)diol, polyglycolide diol, polylactide diol, polycaprolactone(PCL)diol and poly(lactic/glycolic acid) diol, has a molecular weight in the range of 200-100000, preferably 500-10000, more preferably 1000-8000; and the polyethylene glycol that forms the segment B, has a molecular weight of 200-20000, preferably 1000-10000, more preferably 1000-5000.

In the biodegradable polyurethane elastomers of this invention, the molar ratio of the said segments is: (A+B)/C=0.8-1.2, preferably 0.9-1.1, more preferably 1.0; and A/B=0.1 to 10, preferably 0.2 to 5, more preferably 1 to 5; and the molar percent of poly-O— hydroxybutyrate in the segment A is 10-100 mol %, preferably 50-100 mol %.

The preparing process of the biodegradable polyurethane elastomers of the present invention comprises the following steps: Firstly, poly-β-hydroxybutyrate is alcoholysized in an organic solvent with a glycol containing 2-18 carbon atoms, preferably 2-8 carbon atoms, to produce poly(β-hydroxybutyrate) diol oligomer. The catalyst for the alcoholysization reaction is selected from inorganic acids, organic acids and inorganic alkali compounds, preferably selected from hydrochloric acid, sulfuric acid, phosphoric acid, p-methyl benzene sulfonic acid. The alcoholysization reaction is conducted under 40° C.-160° C. The diisocyanates used in the present invention are selected from 1,6-hexamthylene diisocyanate (HDI), isophorone diisocyanate (IPDI) and lysine diisocyanate (LDI), preferably 1,6-hexamthylene diisocyanate (HDI).

### EXAMPLES

The present invention will hereinafter be illustrated by way of examples and drawings. However, these examples and drawings are not construed to limit the scope of the invention.

### Example 1

1. 86 g poly-β-hydroxybutyrate was dissolved in a solution containing 250 ml chloroform and 3.87 g butanediol, and 2 g p-methyl benzene sulfonic acid was added as catalyst, and the mixture was then heated under reflux for 24 hr.

2. the resulting yellow oily liquid was then washed by semi-saturated sodium chloride solution, saturated sodium bicarbonate solution and saturated sodium chloride solution in turn, and the water phase was extracted by chloroform/dichloroethane, then the extract was mixed with the oil phase, and the oil mixture was poured into cold methanol to obtain white precipitate of poly(β-hydroxybutyrate)diol oligomer.

3. 20 g poly(β-hydroxybutyrate)diol oligomer (with a molecular weight of 2000) was added into a 250 ml three-necked bottle and heated to 85° C. under nitrogen protection. 1.68 g 1,6-hexamthylene diisocyanate (HDI) was added into the bottle dropwisely over 3 hours, and the reaction was carried for another 2 hours.

4. the reactant mass was poured into cold de-ionized water to obtain a white elastomer.

### Example 2

1. 86 g poly-β-hydroxybutyrate was dissolved in a solution containing 250 ml chloroform and 4.472 g pentadiol, and 5 g p-methyl benzene sulfonic acid was added as catalyst, and the mixture was then heated under reflux for 24 hr.

2. the resulting yellow oily liquid was then washed by semi-saturated sodium chloride solution, saturated sodium bicarbonate solution and saturated sodium chloride solution in turn, and the water phase was extracted by chloroform/dichloroethane, then the extract was mixed with the oil phase, and the oil mixture was poured into cold methanol to obtain white precipitate of poly(β-hydroxybutyrate)diol oligomer.

3. 18 g poly(β-hydroxybutyrate)diol oligomer (with a molecular weight of 2000) and 2 g polyethylene glycol (with a molecular weight of 2000) were added into a 250 ml three-necked bottle and heated to 110° C. under nitrogen protection. 1.68 g 1,6-hexamthylene diisocyanate (HDI) was added into the bottle dropwisely over 3 hours, and the reaction was carried for another 2 hours.

4. the reactant mass was poured into cold de-ionized water to obtain a white elastomer.

### Example 3

1. 86 g poly-β-hydroxybutyrate was dissolved in a solution containing 250 ml chloroform and 5.074 g hexanediol, and 10 g p-methyl benzene sulfonic acid was added as catalyst, and the mixture was then heated under reflux for 24 hr.

2. the resulting yellow oily liquid was then washed by semi-saturated sodium chloride solution, saturated sodium bicarbonate solution and saturated sodium chloride solution in tun, and the water phase was extracted by chloroform/dichloroethane, then the extract was mixed with the oil phase, and the oil mixture was poured into cold methanol to obtain white precipitate of poly(β-hydroxybutyrate)diol oligomer.

3. 16 g poly(β-hydroxybutyrate)diol oligomer (with a molecular weight of 2000) and 4 g polyethylene glycol (with a molecular weight of 2000) were added into a 250 ml three-necked bottle and heated to 120° C. under nitrogen protection. 2.22 g isophorone diisocyanate (IPDI) was added into the bottle dropwisely over 3 hours, and the reaction was carried for another 2 hours.

4. the reactant mass was poured into cold de-ionized water to obtain a white elastomer.

### Example 4

1. 86 g poly-β-hydroxybutyrate was dissolved in a solution containing 250 ml dichloroethane and 2.666 g ethylene glycol, and 10 g p-methyl benzene sulfonic acid was added as catalyst, and the mixture was then heated under reflux for 24 hr.

2. the resulting yellow oily liquid was then washed by semi-saturated sodium chloride solution, saturated sodium bicarbonate solution and saturated sodium chloride solution in turn, and the water phase was extracted by chloroform/dichloroethane, then the extract was mixed with the oil phase, and the oil mixture was poured into cold methanol to obtain white precipitate of poly(β-hydroxybutyrate)diol oligomer.

3. 14 g poly(β-hydroxybutyrate)diol oligomer (with a molecular weight of 2000) and 6 g polyethylene glycol (with a molecular weight of 2000) were added into a 250 ml three-necked bottle and heated to 95° C. under nitrogen protection. 1.96 g lysine diisocyanate (LDI) was added into the bottle dropwisely over 3 hours, and the reaction was carried for another 2 hours.

4. the reactant mass was poured into cold de-ionized water to obtain a white elastomer.

### Example 5

1. 86 g fermentation poly-β-hydroxybutyrate was dissolved into a solution containing 250 ml dichloroethane and 3.87 g butanediol, and 2 ml phosphoric acid was added as catalyst, and the mixture was then heated under reflux for 24 hr.

2. the thus obtained yellow oily liquid was then washed by semi-saturated sodium chloride solution, saturated sodium bicarbonate solution and saturated sodium chloride solution in turn, and the water phase was extracted by chloroform/dichloroethane, then the extract was mixed with the oil phase, and the oil mixture was poured into cold methanol to obtain white precipitate of poly(β-hydroxybutyrate)diol oligomer.

3. 12 g poly(β-hydroxybutyrate)diol oligomer (with a molecular weight of 2000) and 8 g polyethylene glycol (with a molecular weight of 2000) were added into a 250 ml three-necked bottle and heated to 100° C. under nitrogen protection. 1.68 g 1,6-hexamthylene diisocyanate (HDI) was added into the bottle dropwisely over 3 hours, and the reaction was carried for another 2 hours.

4. the reactant mass was poured into cold de-ionized water to obtain a white elastomer.

### Example 6

1. 86 g fermentation poly-β-hydroxybutyrate was dissolved into a solution containing 250 ml dichloroethane and 3.87 g butanediol, and 2 ml hydrochloric acid was added as catalyst, and the mixture was then heated under reflux for 24 hr.

2. the resulting yellow oily liquid was then washed by semi-saturated sodium chloride solution, saturated sodium bicarbonate solution and saturated sodium chloride solution in turn, and the water phase was extracted by chloroform/dichloroethane, then the extract was mixed with the oil phase, and the oil mixture was poured into cold methanol to obtain white precipitate of poly(β-hydroxybutyrate)diol oligomer.

3. 10 g poly(β-hydroxybutyrate)diol oligomer (with a molecular weight of 2000) and 10 g polyethylene glycol (with a molecular weight of 2000) were added into a 250 ml three-necked bottle and heated to 150° C. under nitrogen protection. 1.96 g lysine diisocyanate (LDI) was added into the bottle dropwisely over 3 hours, and the reaction was carried for another 2 hours.

4. the reactant mass was poured into cold de-ionized water to obtain a white elastomer.

### Example 7

1. 86 g fermentation poly-β-hydroxybutyrate was dissolved into a solution containing 250 ml dichloroethane and 1.935 g butanediol, and 2 ml sulfuric acid was added as catalyst, and the mixture was then heated under reflux for 24 hr.

2. the thus obtained yellow oily liquid was then washed by semi-saturated sodium chloride solution, saturated sodium bicarbonate solution and saturated sodium chloride solution in turn, and the water phase was extracted by chloroform/dichloroethane, then the extract was mixed with the phase, and the oil mixture was poured into cold methanol to obtain white precipitate of poly(β-hydroxybutyrate)diol oligomer.

3. 40 g poly(β-hydroxybutyrate)diol oligomer (with a molecular weight of 4000), 20 g polycaprolactone glycol (with a molecular weight of 2000) and 20 g polyethylene glycol (with a molecular weight of 2000) were added into a 250 ml three-necked bottle and heated to 110° C. under nitrogen protection. 5.053 g 1,6-hexamthylene diisocyanate (HDI) was added into the bottle dropwisely over 3 hours, and the reaction was carried for another 2 hours.

4. the reactant mass was poured into cold de-ionized water to obtain a white elastomer.

### Example 8

1. 86 g fermentation poly-β-hydroxybutyrate was dissolved into a solution containing 250 ml dichloroethane and 2.537 g hexanediol, and 2 ml hydrochloric acid was added as catalyst, and the mixture was then heated under reflux for 24 hr.

2. the thus obtained yellow oily liquid was then washed by semi-saturated sodium chloride solution, saturated sodium bicarbonate solution and saturated sodium chloride solution in turn, and the water phase was extracted by chloroform/dichloroethane, then the extract was mixed with the former oil phase, and the oil mixture was poured into cold methanol to obtain white precipitate of poly(β-hydroxybutyrate)diol oligomer.

3. 40 g poly(β-hydroxybutyrate)diol oligomer (with a molecular weight of 4000), 10 g polycaprolactone glycol (with a molecular weight of 1000) and 20 g polyethylene glycol (with a molecular weight of 1000) were added into a 250 ml three-necked bottle and heated to 130° C. under nitrogen protection. 7.84 g lysine diisocyanate (LDI) was added into the bottle dropwisely over 3 hours, and the reaction was carried for another 2 hours.

4. the reactant mass was poured into cold de-ionized water to obtain a white elastomer.

### Example 9

1. 86 g fermentation poly-β-hydroxybutyrate was dissolved into a solution containing 250 ml dichloroethane and 0.9675 g butanediol, and 2 ml sulfuric acid is added as catalyst, and the reactant mass is then heated under reflux for 24 hr.

2. the thus obtained yellow oily liquid was then washed by semi-saturated sodium chloride solution, saturated sodium bicarbonate solution and saturated sodium chloride solution in turn, and the water phase was extracted by chloroform/dichloroethane, then the extract was mixed with the oil phase, and the oil mixture was poured into cold methanol to obtain white precipitate of poly(β-hydroxybutyrate)diol oligomer.

3. 80 g poly(β-hydroxybutyrate)diol oligomer (with a molecular weight of 8000), 20 g poly(lactic acid)diol (with a molecular weight of 2000) and 20 g polyethylene glycol (with a molecular weight of 1000) were added into a 250 ml three-necked bottle and heated to 120° C. under nitrogen protection. 6.728 g 1,6-hexamthylene diisocyanate (HDI) was added into the bottle dropwisely over 3 hours, and the reaction was carried for another 2 hours.

4. the reactant mass was poured into cold de-ionized water to obtain a white elastomer.

### Example 10

1. 86 g fermentation poly-β-hydroxybutyrate was dissolved into a solution containing 250 ml dichloroethane and 1.935 g butanediol, and 2 ml sulfuric acid was added as catalyst, and the mixture was then heated under reflux for 24 hr.

2. the thus obtained yellow oily liquid was then washed by semi-saturated sodium chloride solution, saturated sodium bicarbonate solution and saturated sodium chloride solution in turn, and the water phase was extracted by chloroform/dichloroethane, then the extract was mixed with the oil phase, and the oil mixture was poured into cold methanol to obtain white precipitate of poly(β-hydroxybutyrate)diol oligomer.

3. 40 g poly(β-hydroxybutyrate)diol oligomer (with a molecular weight of 4000), 10 g poly(lactic acid)diol (with a molecular weight of 1000) and 20 g polyethylene glycol (with a molecular weight of 1000) were added into a 250 ml three-necked bottle and heated to 140° C. under nitrogen protection. 8.88 g isophorone diisocyanate (IPDI) was added into the bottle dropwisely over 3 hours, and the reaction was carried for another 2 hours.

4. the reactant mass was poured into cold de-ionized water to obtain a white elastomer.

The biodegradable polyurethane elastomers of the present invention have the following characteristics and advantages:

1. the molecular weights and contents of the poly-β-hydroxybutyrate segment and polyethylene glycol segment in the polyurethane elastomer is adjustable;

2. the polyurethane elastomer has excellent biodegradability and biocompatibility, and its degradation products are innoxious to organisms;

3. the molecular weight of the resulting polyurethane is adjustable;

4. the hydrophilicity of the resulting polyurethane is adjustable;

5. the decomposition rate of the resulting polyurethane is adjustable.

The hydrophilicities, water-absorbing capacities and biodegradabilities of the biodegradable polyurethane products of the above-mentioned examples are evaluated and compared with those of the prior art products, such as PEC, PUC, PUE and PUF.

Test Methods

1. Test method and standard of water contact angle

The solution of polymer in chloroform was coated on a slide to form a film, and 2 μL de-ionized water was dropped on the polymer film under room temperature, the water contact angle was measured using a JY contact angle scope. Each sample was tested three times.

2. Test method and standard of water-absorbing capacity A polymer will be swelled when it is soaked in water, and the degree of swelling is related directly with water content in the polymer. Therefore, the water-absorbing capacity of a sample can be evaluated by the percentage of the weight increase of the sample after being soaked in water for a certain time.

A sample of the polyurethane film being tested was cut out (20 nm×10 mm×0.3 mm) and suspended on a stainless steel wire and dipped in de-ionized water. The sample was then kept at 37° C. for a certain period. After a predetermined time, the sample was picked up from water and weighted immediately after removing the water on its surface by a filter paper. The percentage of the weight increase of the sample, i.e. swelling degree (SD), was calculated according to the following formula:

SD%=(W₂—W₁)/W₁ (Formula I)

Wherein:

W₁ is the weight of dry sample;

W₂ is the weight of wet sample after being dipped in water for a predetermined time.

Each sample is tested twice.

3. Evaluation method and standard of biodegradability A phosphorus acid solution with a pH value of 7.4 was used as buffer solution.

The biodegradability evaluation was conducted by measuring the residue weight of the sample after being decomposed in the phosphorus acid buffer solution under 37° C. for a certain time. A sample of the polyurethane film being tested was cut out (20 mm×10 mm×0.3 mm) and suspended on a stainless steel wire and dipped in the phosphorus acid buffer solution (pH 7.4). The sample was then kept at 37° C. for a certain period. After a predetermined time, the sample was picked up from the buffer solution, washed with de-ionized water and dried in a vacuum dryer until constant weight was reached. The percentage of the residue weight of the sample was calculated on the basis of the original weight of the sample.

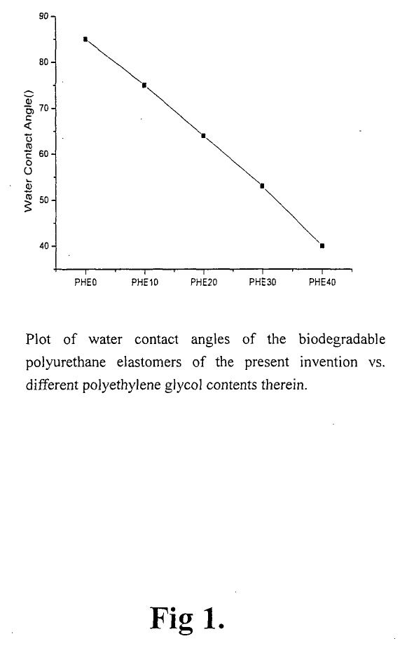

The evaluation results are showed in FIGS. 1-6.

FIG. 1 shows that the products of the present invention have small water contact angles, which means they have good hydrophilicity, and it also shows that the more the content of polyethylene glycol in the product the better the hydrophilicity will be.

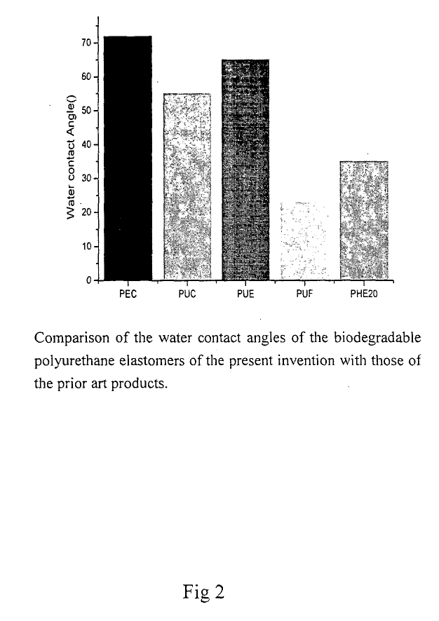

FIG. 2 shows that the water contact angles of the products of the present invention are smaller than those of the prior art products, and that means they have better hydrophilicities.

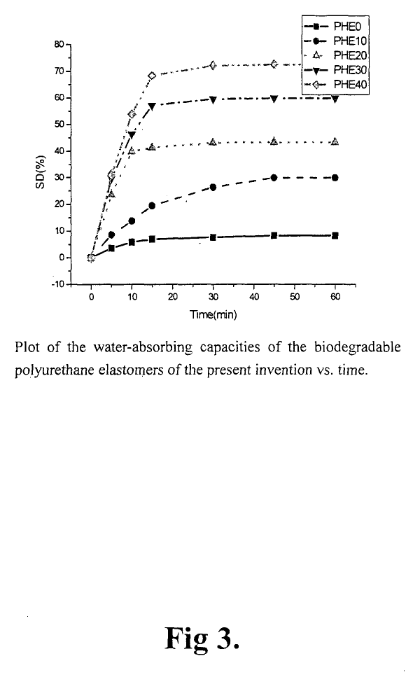

FIG. 3 shows that the products of this invention have high balanced water-absorbing capacities and water-absorbing rates, which are also increasing with the increase of the contents of polyethylene glycol in the products.

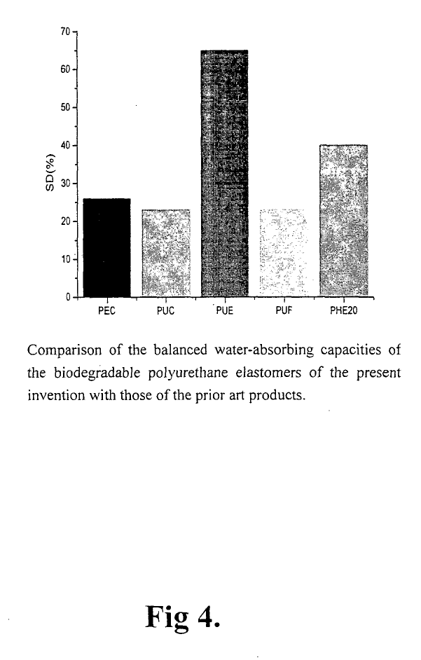

FIG. 4 shows that the balanced water-absorbing capacities of the products of the present invention are higher than those of the prior art products.

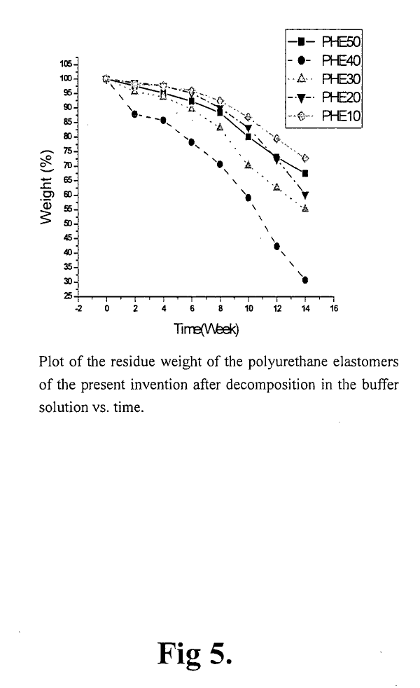

FIG. 5 shows that the decomposition rates of the products of the present invention in the phosphorus acid buffer solution are high, and PHE40 has the highest decomposition rate among the samples.

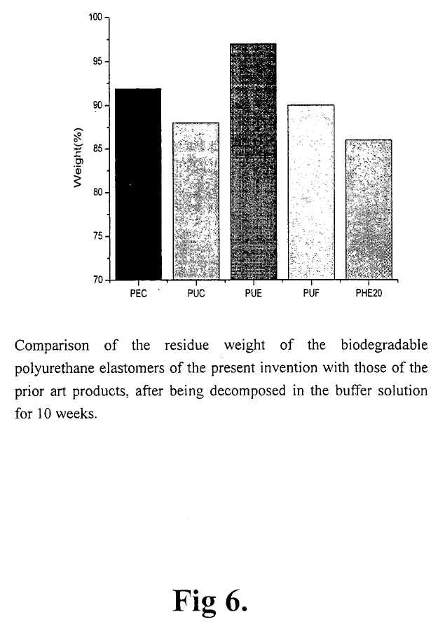

FIG. 6 shows that the decomposition rates of the products of the present invention in the phosphorus acid buffer solution are higher than these of the prior products.

TABLE 1
Samples and their Constitution

| | Constitution of Segments (molar ratio) | | | |
|---|---|---|---|---|
| | A | | B | C |
| Examples | PHB diol | others | (PEG) | (diisocyanate) |
| Example 1 | 100 | 0 | 0 | 100 (HDI) |
| (PHE0) | (Mw 2000) | | | |
| Example 2 | 90 | 0 | 10 | 100 (HDI) |
| (PHE10) | (Mw 2000) | | (Mw 2000) | |
| Example 3 | 80 | 0 | 20 | 100 (IPDI) |
| (PHE20) | (Mw 2000) | | (Mw 2000) | |
| Example 4 | 70 | 0 | 30 | 100 (LDI) |
| (PHE30) | (Mw 2000) | | (Mw 2000) | |
| Example 5 | 60 | 0 | 40 | 100 (HDI) |
| (PHE40) | (Mw 2000) | | (Mw 2000) | |
| Example 6 | 50 | 0 | 50 | 100 (LDI) |
| (PHE50) | (Mw 2000) | | (Mw 2000) | |
| Example 7 | 10 | 10 | 10 | 30 (HDI) |
| | (Mw 4000) | (PCL diol, | (Mw 2000) | |
| | | Mw 2000) | | |
| Example 8 | 10 | 10 | 20 | 40 (LDI) |
| | (Mw 4000) | (PCL diol, | (Mw 1000) | |
| | | Mw 1000) | | |
| Example 9 | 10 | 10 | 20 | 40 (HDI) |
| | (Mw 8000) | (PLA diol, | (Mw 1000) | |
| | | Mw 2000) | | |
| Example 10 | 10 | 10 | 20 | 40 (IPDI) |
| | (Mw 4000) | (PLA diol, | (Mw 1000) | |
| | | Mw 1000) | | |

We claim:

1. A biodegradable polyurethane elastomer comprising soft segments A and B, and hard segment C, wherein:
the segment A is formed from poly(β-hydroxybutyrate) diol and optional one or more components selected from the group consisting of poly(lactic acid)diol, polyglycolide diol, polylactide diol, polycaprolactone(PCL) diol and poly(lactic/glycolic acid) diol;
the segment B is formed from polyethylene glycol;
the segment C is formed from one or more diisocyanate selected from the group consisting of 1,6-hexamthylene diisocyanate, isophorone diisocyanate and lysine diisocyanate; and
the molar ratio of these segments are: (A+B)/C=0.8 to 1.2; A/B=0.1 to 10; and the amount of the poly-β-hydroxybutyrate units in the segment A is 10-100 mol %.

2. The biodegradable polyurethane elastomer of claim 1, wherein the molar ratio of the said segments is: (A+B)/C=0.9 to 1.1 and A/B=0.2 to 5.0.

3. The biodegradable polyurethane elastomer of claim 2, wherein the molar ratio of the said segments is: (A+B)/C=1.0 and A/B=1 to 5.

4. The biodegradable polyurethane elastomer of claim 1, wherein each of the poly(1-hydroxybutyrate)diol and the optional components selected from the group consisting of poly(lactic acid)diol, polyglycolide diol, polylactide diol, polycaprolactone(PCL)diol and poly(lactic/glycolic acid) diol, has a molecular weight in the range of 200-100000.

5. The biodegradable polyurethane elastomer of claim 1, wherein the segment B is formed from polyethylene glycol with molecular weight of 200-20000.

6. The biodegradable polyurethane elastomer of claim 1, wherein the amount of poly-β-hydroxybutyrate units in the segment A is 50-100 mol %.

7. A process for preparing biodegradable polyurethane elastomers, which comprises the following steps:
1) poly-β-hydroxybutyrate is mixed with a glycol of C₂-C₈ and alcoholysized under heat reflux;
2) the product of step 1) is purified via extraction to obtain poly(β-hydroxybutyrate)diol oligomer;
3) polyethylene glycol and optional one or more components selected from the group consisting of polycaprolactone diol, poly(lactic acid) diol, polyglycolide diol, polylactide diol and poly(lactic/glycolic acid) diol are added into the poly(β-hydroxybutyrate)diol oligomer, and the mixture is heated under nitrogen protection, and then one or more diisocyanates selected from the group consisting of 1,6-hexamthylene diisocyanate (HDI), isophorone diisocyanate (IPDI) and lysine diisocyanate (LDI) are added into the reaction mass, and the reaction is carried out at 80° C.-150° C.;
4) the reaction product is cooled and the biodegradable polyurethane elastomer of the present invention is obtained comprising soft segments A and B, and hard segment C, wherein:
the segment A is formed from poly(β-hydroxybutyrate) diol and optional one or more components selected from the group consisting of poly(lactic acid)diol, polyglycolide diol, polylactide diol, polycaprolactone(PCL) diol and poly(lactic/glycolic acid) diol;
the segment B is formed from polyethylene glycol;
the segment C is formed from one or more diisocyanate selected from the group consisting of 1,6-hexamthylene diisocyanate, isophorone diisocyanate and lysine diisocyanate.

8. The process for preparing biodegradable polyurethane elastomers of claim 7, wherein the catalyst for the alcoholysization reaction of step 1) is selected from inorganic acids, organic acids and inorganic alkali compounds.

9. The process for preparing biodegradable polyurethane elastomers of claim 8, wherein the said catalyst is selected from hydrochloric acid, sulfuric acid, phosphoric acid and p-methyl benzene sulfonic acid.

10. The process for preparing biodegradable polyurethane elastomers of claim 7, wherein each of the poly(1-hydroxybutyrate)diol and the optional components selected from the group consisting of poly(lactic acid)diol, polyglycolide diol, polylactide diol, polycaprolactone(PCL)diol and poly(lactic/glycolic acid) diol, has a molecular weight in the range of 200-100000.

11. The process for preparing biodegradable polyurethane elastomers of claim 7, wherein the molecular weight of the polyethylene glycol used in step 3) is in the range of 200-20000.

12. The process for preparing biodegradable polyurethane elastomers of claim 7, wherein the molar ratio of the segments in the polyurethane product is: (A+B)/C=0.8 to 1.2; A/B=0.1 to 10; and the amount of poly-β-hydroxybutyrate units in the segment A is 10-100 mol %.
